(19) United States
(12) Patent Application Publication
(10) Pub. No.: US 2001/0017045 A1
(43) Pub. Date: Aug. 30, 2001

(54) Unit for notching a sheet of laminated glass

(76) Inventors: Roberto Mattio, Piasco (IT); Giacomo Aimar, Cervasca (IT)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/749,877

(22) Filed: Dec. 29, 2000

(30) Foreign Application Priority Data
Jan. 14, 2000 (IT) TO2000A000036

(51) Int. Cl. C03B 33/03

(52) U.S. Cl. 65/174; 83/879

(57) ABSTRACT

A unit for notching a sheet of laminated glass has a supporting surface for the sheet to be notched; two straight, parallel guides on opposite sides of the supporting surface: and two notching heads running along respective guides to effect two notch lines on opposite surfaces of the sheet of laminated glass; the sheet being moved on the supporting surface by means of a gripping and handling head, which engages the sheet, has a respective axis of symmetry perpendicular to the supporting surface, and is activated by a first actuating device to rotate in opposite directions about the axis, and by a second actuating device to translate in a direction perpendicular to the axis.

The present invention relates to a unit for notching a sheet of laminated glass.

### BACKGROUND OF THE INVENTION

As is known, sheets of laminated glass are notched on units comprising a supporting surface for the sheet to be notched, and two notching heads located above and below the supporting surface and each fitted to a respective straight guide on which to travel in opposite directions along a straight notching path. On the supporting surface, the sheets are moved in a direction perpendicular to said directions by means of powered belts or straightforward air cushions—which are prevented, however, from being used on such units on account of the opening in the supporting surface for passage of the bottom notching head tool—and are also rotated 90° by means of gripping heads fitted to, and rotating about an axis perpendicular to, the supporting surface.

At each forward feed movement of the sheet, the notching heads form a number of parallel or perpendicular notch lines, along which the sheet is subsequently broken up onto a number of parallel-sided articles.

Though widely used for producing rectangular or square glass articles, known units of the above type are particularly unsuitable for notching oblique or curved lines and, consequently, for producing articles not only with nonparallel sides but, above all, of exactly the same shape and size.

### SUMMARY OF THE INVENTION

It is an object of the present invention to provide a unit for notching sheets of laminated glass, designed to provide a straightforward, low-cost solution to the aforementioned drawback.

According to the present invention, there is provided a unit for notching a sheet of laminated glass, comprising a supporting surface for the sheet of laminated glass to be notched; two notching heads running along respective straight paths parallel to said supporting surface so as to effect two notch lines on opposite surfaces of said sheet of laminated glass; and handling means for moving said sheet of laminated glass on said supporting surface; said handling means comprising a gripping head for gripping said sheet and having a respective barycentric axis perpendicular to the supporting surface, and first actuating means for rotating said gripping head with respect to said supporting surface about said barycentric axis; characterized in that said handling means also comprise second actuating means for moving the gripping head with respect to said supporting surface in a first direction perpendicular to the barycentric axis.

### BRIEF DESCRIPTION OF THE DRAWINGS

A non-limiting embodiment of the invention will be described by way of example with reference to the accompanying drawings, in which:

FIG. 1 shows a schematic plan view of a preferred embodiment of the notching unit according to the present invention;

FIG. 2 shows a smaller-scale section, with parts removed for clarity, along line II-II in FIG. 1;

FIG. 3 shows the same view as in FIG. 2, with parts of FIG. 2 in a different operating position;

FIG. 4 shows an enlarged view in perspective of a detail in FIGS. 1 to 3;

FIG. 5 shows a section of a variation of a detail in FIG. 3;

FIGS. 6 to 9 show smaller-scale views of parts of FIG. 1 in four different operating positions;

FIG. 10 shows a section, with parts removed for clarity, along line X-X in FIG. 1.

### DETAILED DESCRIPTION OF THE INVENTION

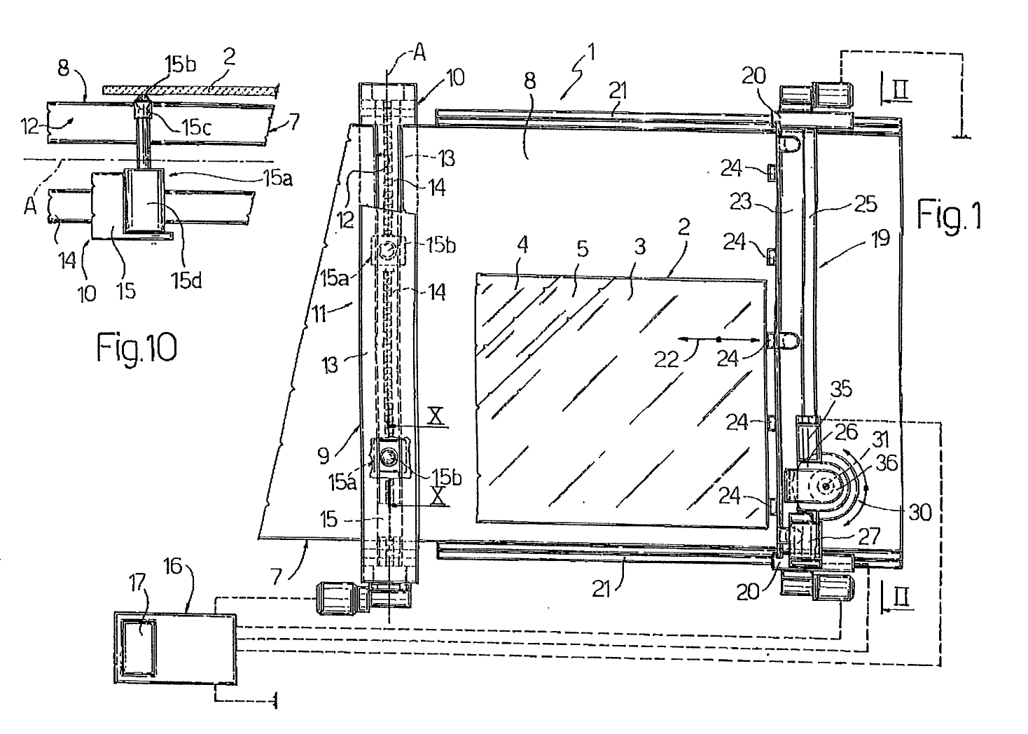

Number 1 in FIGS. 1 to 3 indicates as a whole a unit for notching a sheet 2 of laminated, so-called nonshattering, glass comprising two sheets 3 and 4 of glass separated by a layer 5 of thermoplastic material.

Unit 1 comprises a table 7 defining a supporting surface 8 for sheet 2 and supporting a top notching bridge 9 and a bottom notching bridge 10, which are located one over the other at a notching station 11 and facing a straight opening 12 formed through supporting surface 8 in a direction A. Bridges 9 and 10 comprise respective cross members 13 facing each other and fitted integrally with respective straight guides 14 parallel to each other and lying in the same plane perpendicular to the supporting surface. A respective powered slide 15 (FIG. 1) is fitted in axially-sliding manner to each guide 14, and supports a respective known notching tool (not shown) designed to travel in direction A to form a notch line in the relative sheet 3, 4 of glass. With reference to FIG. 1, and particularly to FIG. 10, slide 15 of bridge 10 also carries a supporting device 15a for supporting sheet 2, and which, in the example described, comprises a spherical body 15b housed for rotation inside a spherical seat on an end portion 15c of the output rod of a pneumatic linear actuator 15d. Portion 15c is narrower than opening 12 and is movable by actuator 15d between a raised work position shown in FIG. 10 and in which it engages opening 12 and body 15b contacts sheet 2 to support the sheet detached from supporting surface 8, and a rest position in which body 15b extends completely beneath supporting surface 8.

Slides 15 and device 15a are controlled by a known central control unit 16 comprising a memory block 17 for storing the lines to be notched in sheet 2.

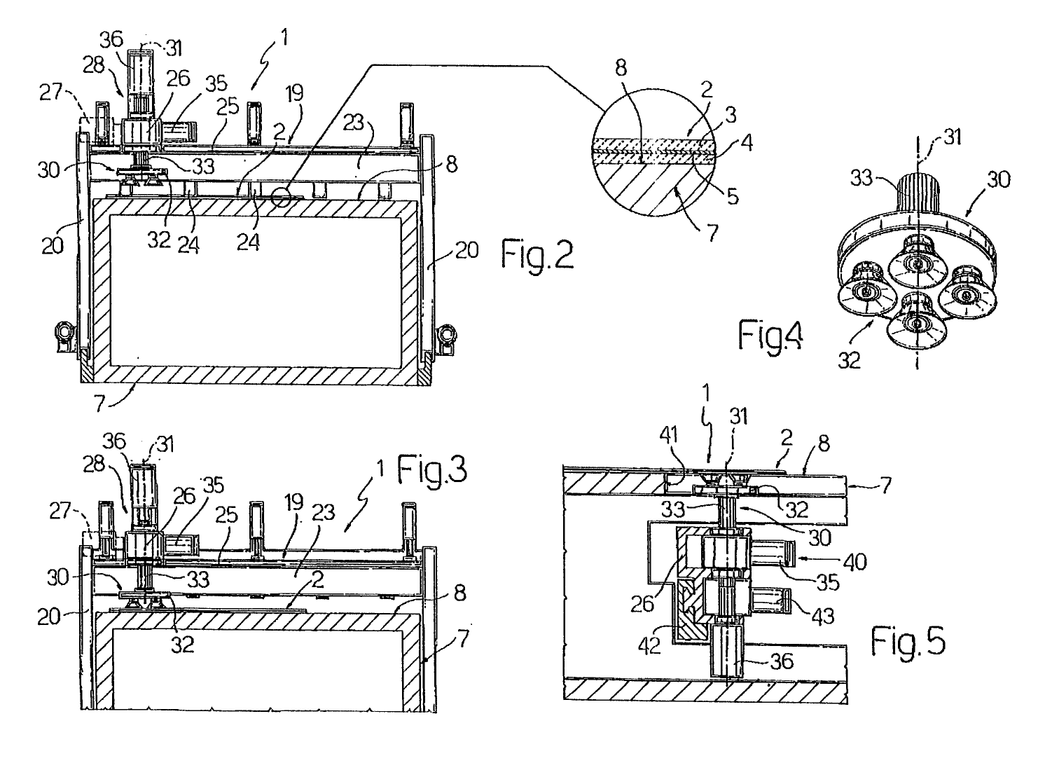

With reference to FIG. 1, table 7 also supports a powered locating bridge 19 extending over supporting surface 8 and comprising two uprights 20 connected to respective guides 21, in turn connected integrally to table 7, so as to slide back and forth, parallel to supporting surface 8, in a direction 22 perpendicular to guides 14 and under the control of central control unit 16. Bridge 19 comprises a cross member 23 parallel to and detached from supporting surface 8, and which supports a number of appendixes 24 extending towards surface 8 and movable, by means of respective known pneumatic actuators not described in detail, to and from a lowered position (FIG. 2) in which they define respective locators for locating and maintaining sheet 2 in a reference position. Cross member 23 is also fitted integrally with a straight guide 25 perpendicular to direction 22 and parallel to surface 8, and which in turn is fitted with a slide 26 which is moved axially along guide 25 by a respective motor 27 controlled by central control unit 16. Slide 26, guide 25, locating bridge 19 and supporting device 15a form part of an assembly 28 for handling sheet 2, and which also comprises a gripping and handling member 30 (FIGS. 2, 3, 4) fitted to slide 26, having a respective axis of symmetry 31 perpendicular to supporting surface 8, and in turn comprising a suction-cup-type gripping head 32 for gripping sheet 2, and a shank 33. Shank 33 is connected to slide 26 so as to rotate about axis 31, by virtue of a known, e.g. worm-helical gear, transmission (not shown) activated by an electric motor 35 connected to central control unit 16, and so as to translate in opposite directions along axis 31 to and from supporting surface 8 by virtue of a known pneumatic actuator 36 not described in detail (FIGS. 2 and 3).

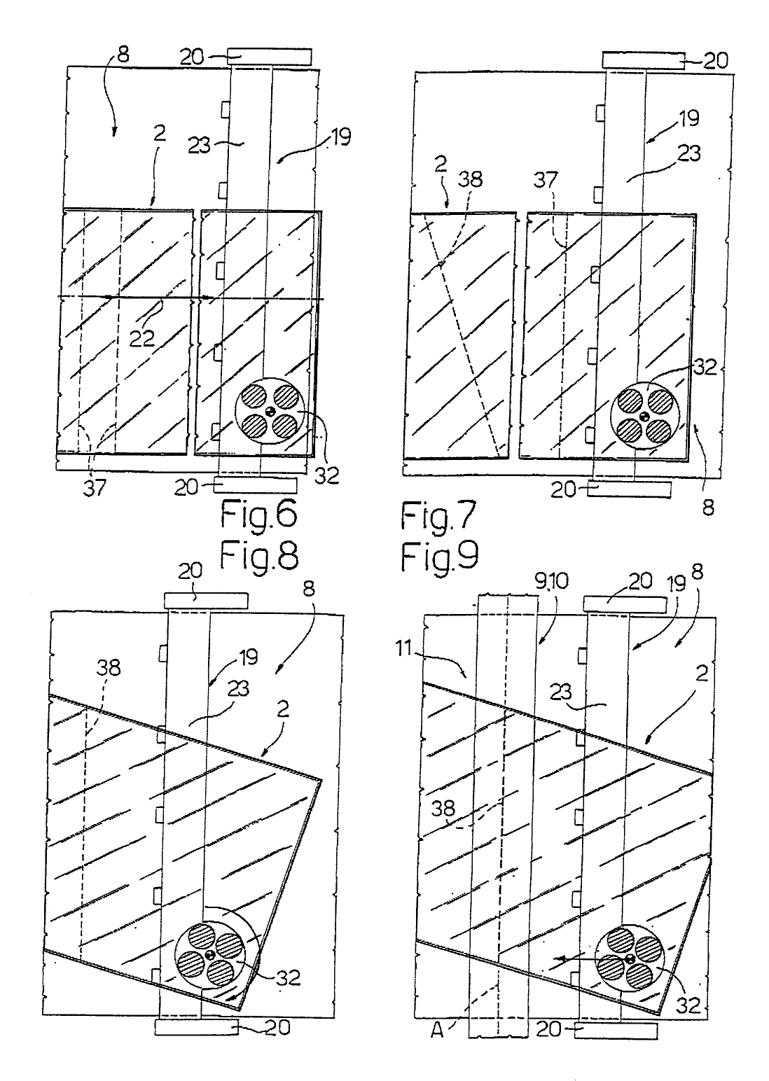

In actual use, to form on sheet 2 a number of straight, parallel notch lines 37, as shown in FIG. 6, gripping head 32 engaging sheet 2 is maintained in a fixed position with respect to locating bridge 19; and, following the work stroke of the notching tools in direction A, bridge 19 is moved in steps in direction 22, possibly after first lifting head 32 by means of actuator 36 to reduce drag on sheet 2.

To form a straight notch line 38 sloping with respect to lines 37, as shown in FIG. 7, head 32 engaging sheet 2 is raised and, at the same time, actuator 15d is activated to move portion 15c into the raised work position to detach sheet 2 from supporting surface 8. At this point, by rotating head 32 about axis 31 and moving bottom slide 15 along respective guide 14 so that body 15b is maintained constantly engaging sheet 2, line 38 is positioned parallel to direction A, as shown in FIG. 8; and locating bridge 19 is then moved in direction 22 so that line 38 coincides with direction A, as shown in FIG. 9. At this point, portion 15c is restored to the lowered position, head 32 is moved towards supporting surface 8, and slides 15 are moved along guides 14 to notch both sheets 3 and 4 of glass defining sheet 2.

If the notch lines to be formed in sheets 3 and 4 of glass comprise at least one curved portion, this is achieved by combining rotation of head 32 about axis 31 and translation of locating bridge 19 and of slides 15 and 26 along respective guides 14 and 25.

In the FIG. 5 variation, unit 1 comprises a sheet 2 handling assembly 40 extending beneath supporting surface 8, and which differs from assembly 28 by head 32 engaging a through opening 41 formed through the portion of table 7 defining supporting surface 8. In the example shown, assembly 40 also differs from assembly 28 by slide 26—to which shank 33 of member 30 is connected to rotate about and slide axially along axis 31—being connected to a fixed guide 42, connected integrally to table 7, so as to only slide in direction 22 by virtue of a respective motor 43.

In a variation not shown, guide 42 is fitted to a further slide connected to table 7 so as to slide in a direction perpendicular to direction 22.

Using a head 32 rotated about a respective axis 31 and moved in one or more directions by a central control unit 16 therefore provides for forming in sheet 2, not only the usual parallel or perpendicular notch lines 37, but also any notch line 38 sloping with respect to lines 37, and, above all, notch lines having curved portions of any sort. Moreover, memorizing the geometry of the notch lines in central control unit 16 provides for obtaining, when sheet 2 is broken up along the notch lines, laminated glass articles which are not only extremely precise but also the same shape and size.

Using a straightforward gripping head and a powered handling assembly also meets increasing demand for a notching unit which is cheaper to produce and maintain, is more compact, and can therefore be operated either independently or as part of a mass production system, between a sheet supply unit and a notched sheet breakoff unit.

Finally, using a supporting device which is movable inside opening 12 provides for easily maneuvering sheets of any shape or size on the supporting surface, with no jamming or slippage on the supporting surface which might affect the position of the sheet, thus enabling the formation of articles of exactly the same shape and size and hence a high standard of quality of the finished product.

Clearly, changes may be made to unit 1 as described herein without, however, departing from the scope of the present invention. In particular, gripping and handling member 30 may be other than as described herein, and be activated by actuating assemblies other than those described by way of example. In particular, as opposed to being carried by locating bridge 19, gripping member 30 may be carried by a powered actuating member of its own associated with table 7.

Device 15a may be other than as described by way of example. In particular, pneumatic actuator 15d may be replaced with an angular actuator with a mechanical transmission of any type between the angular actuator and portion 15c, and body 15b may be replaced with one or more auxiliary supporting bodies.

Finally, notching bridges 9 and 10 may be connected tot able 7 by and adjusting device for adjusting the position of the notching tools with respect to direction A and to opening 12 for the passage of the bottom notching tool.

1. A unit (1) for notching a sheet (2) of laminated glass, comprising a supporting surface (8) for the sheet (2) of laminated glass to be notched; two notching heads (15) facing each other and running along respective straight paths (14) parallel to said supporting surface (8) so as to effect two notch lines (37; 38) on opposite surfaces of said sheet (2) of laminated glass; and handling means (28; 40) for moving said sheet (2) of laminated glass on said supporting surface (8); said handling means (28; 40) comprising a gripping head (32) for gripping said sheet (2) and having a respective barycentric axis (31) perpendicular to the supporting surface (8), and first actuating means (35) for rotating said gripping head (32) with respect to said supporting surface (8) about said barycentric axis (31); characterized in that said handling means (28; 40) also comprise second actuating means (19); (43) for moving the gripping head (32) with respect to said supporting surface in a first direction (22) perpendicular to the barycentric axis (31).

2. A unit as claimed in claim 1, characterized in that said first direction (22) is perpendicular to said straight paths (14).

3. A unit as claimed in claim 1, characterized by also comprising third actuating means (27) for moving said gripping head (32) in a second direction (25) perpendicular to said first direction (22).

4. A unit as claimed in claim 3, characterized in that said second direction (25) extends parallel to said supporting surface (8).

5. A unit as claimed in claim 1, characterized in that said gripping head (32) is located entirely over said supporting surface to engage a top surface of the sheet (2) on the supporting surface (8).

6. A unit as claimed in claim 5, characterized by comprising a locating bridge (19) extending over said supporting surface (8) to position said sheet (2) on the supporting surface (8) in a reference position; said locating bridge (19) carrying said gripping head (32) and being movable in said first direction (22).

7. A unit as claimed in claim 6, characterized in that said locating bridge (19) comprises a respective straight guide (25) perpendicular to said first direction (22); and a powered slide (26) connected in axially-sliding manner to the guide (25) of the locating bridge (19); said gripping head (32) being carried by said powered slide (26).

8. A unit as claimed in claim 1, characterized in that said gripping head (32) and at least said first (35) and second (43) actuating means are located beneath said supporting surface (8) to engage a bottom surface of the sheet (2) on the supporting surface (8).

9. A unit as claimed in claim 1, characterized by comprising further actuating means (36) for moving said gripping head (32) to and from said supporting surface (8).

10. A unit as claimed in claim 1, characterized in that said handling means also comprise supporting means (15b) for supporting said sheet (2) and movable with respect to said supporting surface (8); powered fourth actuating means (15) being provided to move said supporting means (15b) with respect to said supporting surface (8) in a direction parallel to said straight paths (14).

11. A unit as claimed in claim 10, characterized by comprising fifth actuating means (15d) for moving said supporting means (15b) to and from said supporting surface (8).

12. A unit as claimed in claim 10, characterized in that said supporting surface comprises an opening (12); and in that said supporting means (15b) are movable through said opening (12).
